(19) United States
(12) Patent Application Publication
(10) Pub. No.: US 2026/0066692 A1
(43) Pub. Date: Mar. 5, 2026

(54) METHOD AND DEVICE FOR SWITCHING POWER SUPPLY IN ELECTRIC POWER SYSTEM

(71) Applicant: Siemens Aktiengesellschaft, München (DE)

(72) Inventors: Yan Ma, Nanjing (CN); Jun Hong Li, Nanning (CN); Lei Ming Qin, Nanjing (CN); Klaus Böhme, Berlin (DE); Zhi Xiong Liu, Nanjing (CN); Sebastian Schneider, Oberasbach (DE); Ya Li Wang, Nanjing (CN); Gu Gong, Nanjing (CN); Hai Tao Lian, Nanjing (CN); Fei Wang

(21) Appl. No.: 19/108,223

(22) PCT Filed: Aug. 31, 2023
(86) PCT No.: PCT/EP2023/073874

§ 371 Date: Mar. 3, 2025

(30) Foreign Application Priority Data
Sep. 1, 2022 (CN) 202211065461.8

(51) Int. Cl. H02J 9/06; H02J 3/00; H02J 13/00

(52) U.S. Cl. CPC H02J 9/068; H02J 3/0012; H02J 13/12

(57) ABSTRACT

A method and a device for power supply switching in an electric power system include providing an electric power system having two power supplies, each connected to a bus through an incoming line, using the power supply currently supplying power as the main power supply, using the other power supply as a backup power supply, and respectively connecting the two power supplies to a power supply station of a higher level. Upon identifying a trigger condition, sampling of power data on the bus is started, with the trigger condition being used to decide that a fault of the electric power system is eliminated and power is lost from the main power supply. If the time period for sampling of power data reaches a preset threshold, it is determined whether the condition for circuit-closing of the backup power supply is satisfied according to each sampled power data value.

### TECHNICAL FIELD

The present invention relates to the field of electric power systems, and in particular to a method and a device for switching a power supply in an electric power system.

### BACKGROUND ART

In many factories, an electric power system generally has two power supplies, one that is currently supplying power is used as the main power supply, and the other is used as the backup power supply. These two power supplies are respectively connected to a power supply station of the higher level. For example, the two power supplies may be connected to the same power supply station of the higher level, but to different buses. It is necessary to disconnect the main power supply in some circumstances, for example, in case of a failure of the line of this level, or a failure of the power supply station of the higher level. To ensure uninterrupted power supply, it is necessary to switch the power supply from the main power supply to the backup power supply as quickly as possible. In the prior art, quick switching devices are generally used to switch power supplies.

In terms of the switching mode, quick switching devices may be classified as three types: series switching, parallel switching and simultaneous switching. In China, series switching is generally adopted, i.e., after the quick switching device receives the start signal, it firstly decides whether the circuit breaker of the main power supply is completely disconnected, then collects power data and decides whether the backup power supply meets the condition for circuit-closing after it is verified that the circuit breaker is completely disconnected, and selects the appropriate time to switch over to the backup power supply according to the condition for circuit-closing.

For quick switching devices, deciding whether the backup power supply meets the closing conditions as soon as possible becomes an urgent problem to be solved.

### SUMMARY OF THE INVENTION

In view of the above, the present invention proposes a method for switching the power supply in an electric power system. The electric power system comprises two power supplies, each of the power supplies is connected to a bus through an incoming line, one power supply currently supplying power is used as a main power supply, the other power supply is used as a backup power supply, and the two power supplies are respectively connected to a power supply station of the higher level. The method comprises:
if a trigger condition is identified, starting sampling of power data on the bus, the trigger condition being used to decide that a fault of the electric power system is eliminated and power is lost from the main power supply; and
if a time period for sampling of power data reaches a preset threshold, determining whether a condition for circuit-closing of the backup power supply is satisfied according to each sampled value of the power data.

In the method described above, optionally, before starting sampling of power data on the bus, it further comprises:
determining that a trigger condition is identified if a return signal sent by a fault detection element is received.

In the method described above, optionally, before starting sampling of power data on the bus, it further comprises:
determining that a trigger condition is identified if position information is received indicating that a circuit breaker of the main power supply is in an open position.

In the method described above, optionally, after starting sampling of power data on the bus and before determining whether a condition for switching on the backup power supply is satisfied according to each sampled value of the power data, it further comprises:
verifying whether the circuit breaker of the main power supply has no current, and, if the verification result is yes, performing the operation of determining whether a condition for switching on the backup power supply is satisfied according to each sampled value of the power data.

In the method described above, optionally, after a trigger condition is identified, it comprises:
monitoring a current of the main power supply, and determining whether the circuit breaker of the main power supply is completely disconnected according to a value of the current of the main power supply.

In the method described above, optionally, determining whether the circuit breaker of the main power supply is completely disconnected according to a value of the current of the main power supply comprises:
obtaining a target value according to a sampled value of the current, the target value=an Nth sampled current value−an (N−1)th sampled current value, wherein N is a positive integer; and
if an absolute value of consecutive M target values is less than or equal to a preset threshold, determining that the circuit breaker of the main power supply is completely disconnected, wherein M is a positive integer.

In the method described above, optionally, M≥a number of sampled values of a half cycle of the current.

The present invention also provides a quick switching device. The quick switching device is located in an electric power system, the electric power system comprises two power supplies, each of the power supplies is connected to a bus through an incoming line, one power supply currently supplying power is used as the main power supply, the other power supply is used as a backup power supply, and the two power supplies are respectively connected to a power supply station of the higher level. The quick switching device comprises:
an acquisition unit, used for, if a trigger condition is identified, starting sampling of power data on the bus, the trigger condition being used to decide that a fault of the electric power system is eliminated and power is lost from the main power supply; and
a determining unit, used for, if a time period for sampling of power data reaches a preset threshold, determining whether a condition for circuit-closing of the backup power supply is satisfied according to each sampled value of the power data.

In the quick switching device described above, optionally, the acquisition unit is specifically used for:
determining that a trigger condition is identified if a return signal sent by a fault detection element is received.

In the quick switching device described above, optionally, the acquisition unit is specifically used for:
determining that a trigger condition is identified if position information is received indicating that a circuit breaker of the main power supply is in an open position.

In the quick switching device described above, optionally, it further comprises:
a verifying unit, used for verifying whether the main power supply has no current, and triggering the determining unit if the verification result is yes.

In the quick switching device described above, optionally, it further comprises:
a monitoring unit, used for monitoring a current of the main power supply, and determining whether the circuit breaker of the main power supply is completely disconnected according to a value of the current of the main power supply.

In the quick switching device described above, optionally, the monitoring unit is specifically used for:
obtaining a target value according to a sampled value of the current, the target value=an Nth sampled current value−an (N−1)th sampled current value, wherein N is a positive integer; and
if an absolute value of consecutive M target values is less than or equal to a preset threshold, determining that the circuit breaker of the main power supply is completely disconnected, wherein M is a positive integer.

The present invention also provides a quick switching device, comprising:
at least one memory, used for storing an instruction; and
at least one processor, used for executing the method for power supply switching in an electric power system as described in any of the above paragraphs according to the instruction stored in the memory.

The present invention further provides a readable storage medium, with a machine-readable instruction stored therein, which, when executed by a machine, causes the machine to execute the method for power supply switching in an electric power system according to any of the paragraphs above.

As can be seen from the solution described above, when a trigger condition is identified which indicates that a fault of the electric power system is eliminated and power is lost from the main power supply, the power data on the bus is immediately sampled, so that there is no need to wait for the circuit breaker of the main power to completely open before starting sampling, thereby saving time to obtain a sufficient amount of power data as soon as possible for determining whether the closing condition is met and then triggering the switching operation of the power supply as soon as possible.

### BRIEF DESCRIPTION OF THE DRAWINGS

Preferred embodiments of the present invention are described in detail below with reference to the drawings, to give those skilled in the art a clearer understanding of the above-mentioned and other features and advantages of the present invention. In the figures:

FIG. 1 is a schematic structural diagram of a part of an electric power system having the quick switching device according to one embodiment of the present invention.

FIG. 2 is a schematic flowchart of the method for power supply switching in an electric power system according to one embodiment of the present invention.

FIG. 3A is a schematic flowchart of the method for power supply switching in an electric power system according to another embodiment of the present invention.

FIG. 3B is a time-series instance diagram of the method for power supply switching in an electric power system shown in FIG. 3A.

FIG. 4 is a schematic flowchart of the method for power supply switching in an electric power system according to yet another embodiment of the present invention.

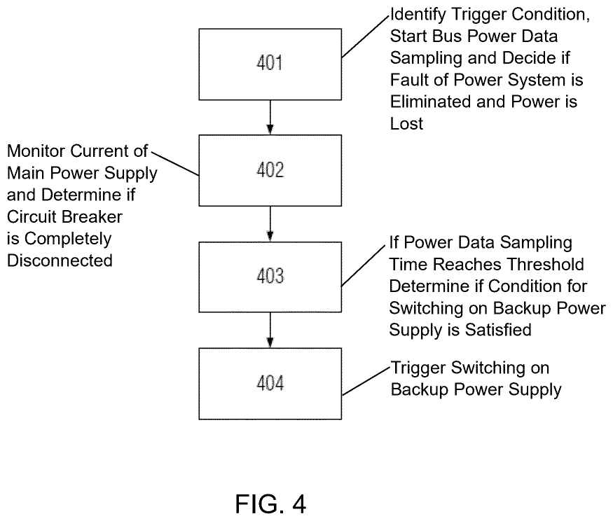

FIG. 5 is a schematic structural diagram of the quick switching device according to one embodiment of the present invention.

FIG. 6 is a schematic structural diagram of the quick switching device according to another embodiment of the present invention.

FIG. 7 is a schematic structural diagram of the quick switching device according to yet another embodiment of the present invention.

### SPECIFIC EMBODIMENTS

In order to make clearer the purposes, technical solutions, and advantages of the present invention, the present invention will be further described below in conjunction with embodiments.

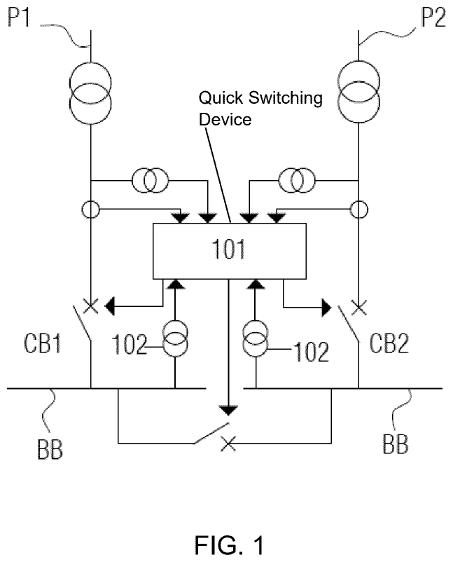

FIG. 1 is an exemplary schematic structural diagram of a part of an electric power system having a quick switching device. In the electric power system of this level, one power supply that is currently supplying power is used as the main power supply, and another is used as the backup power supply. The main power supply P1 is connected to the bus through an incoming line, and the backup power supply P2 is also connected to the bus through an incoming line. The three phases in the incoming line are phase A, phase B and phase C, which are respectively connected to the corresponding three phases of the bus BB. Each load is connected to the bus BB through outgoing lines. That is, the incoming lines, the bus and the outgoing lines on phase A are connected together, and the respective incoming lines, the bus and the outgoing lines on phase B and C are also connected together. The incoming line of the main power supply P1 has a circuit breaker CB1, and the main power supply P1 can be disconnected from the bus BB by the circuit breaker CB1. The incoming line of the backup power supply P2 has a circuit breaker CB2, and the backup power supply can be disconnected from the bus BB by the circuit breaker CB. The main power supply P1 and the backup power supply P2 are respectively connected to a power supply station of the higher level, for example, to different buses of the same power supply station of the higher level, or to different power supply stations of the higher level.

When the electric power system fails, the relay protection device will be started to disconnect the main power supply P1 that is currently supplying power and will trigger the operation of the quick switching device 101, and the quick switching device 101 will quickly switch the bus BB to the backup power supply P2. A voltage sensor 102 is provided on each phase between the circuit breaker CB1 and the bus BB in FIG. 1, and the voltage data of each phase in the incoming lines is obtained through the voltage sensors 102 to monitor the voltage in real time.

However, an exemplary scenario in the prior art is self-starting: when the upper-level power supply station connected to the main power supply P1 fails, the quick switching device of the electric power system of this level will not receive any signal to trigger power supply switching. The fault detection element of the electric power system locks the power switching function of the quick switching device, and unlocks the power switching function of the quick switching device when the fault of the electric power system is eliminated. The fault detection element can determine whether the fault of the electric power system has been eliminated according to a fault characteristic quantity of the voltage. Specifically, it can make a decision according to fault characteristic quantities such as zero-sequence voltage or negative-sequence voltage. The specific method for the determination is in the prior art and will not be detailed here. It should be noted here that the elimination of the fault of the electric power system means that no faulty line is connected to the electric power system, i.e., the fault of the power supply station of the higher level has been eliminated, or the electric power system has been separated from the faulty line of the power supply station of the higher level, and thus power is lost from the main power supply. Next, the quick switching device automatically triggers the disconnection of the circuit breaker of the main power supply. After confirming that the circuit breaker is completely disconnected, it starts to collect power data on the bus, and the backup power supply is switched on when it is decided that the closing conditions are met according to the power data.

The inventors have found that, in the prior art described above, it is necessary to wait for the circuit breaker of the main power supply to be completely disconnected before obtaining power data for the closing conditions, and a certain time period between the triggering of disconnection of the circuit breaker of the main power supply by the quick switching device and the identification of the complete disconnection of the circuit breaker of the main power supply leads to delay in the closing to a certain extent. Based on this, the inventors have invented a method for switching the power supply in electric power systems to achieve faster closing.

### Embodiment 1

This embodiment provides a method for switching the power supply in an electric power system, and the method is implemented by a quick switching device.

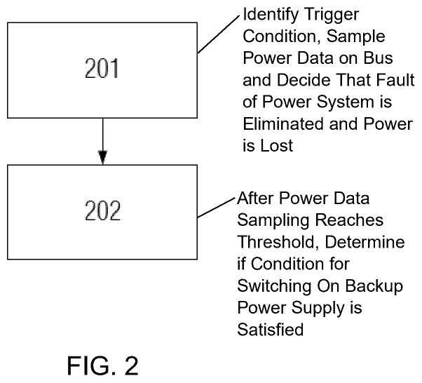

FIG. 2 is a schematic flowchart of the method for power supply switching in an electric power system according to this embodiment. The method for power supply switching in an electric power system comprises:

Step 201, if a trigger condition is identified, starting sampling of power data on the bus, the trigger condition being used to decide that a fault of the electric power system is eliminated and power is lost from the main power supply.

After it is decided that the fault of the electric power system of this level is eliminated and power is lost from the main power supply, sampling of power data on the bus will be started. The loss of power from the main power here means that the main power supply is unable to provide power. For example, power from the upper-level power supply station of the main power is lost, and power cannot be supplied to the main power supply, or the circuit breaker of the main power is disconnected, it cannot provide power for the load connected to the bus. The elimination of the fault of the electric power system of this level here means that no faulty line is connected to the electric power system of this level.

As an example, after receiving a return signal sent by a fault detection element, it can be determined that a trigger condition has been identified. The fault detection element is in the prior art, it is a device in the electric power system of this level and can decide whether there is still a fault in the electric power system of this level. It may be provided in the relay protection device or in the quick switching device, which may be determined according to actual needs. Since the main power supply will be disconnected immediately when there is a fault in the electric power system of this level, the decision of the fault detection element that the fault has been eliminated means that the conditions of elimination of the fault of the electric power system and loss of power from the main power supply are met. For another example, after the circuit breaker of the power supply of the upper-level power supply station corresponding to the main power supply is disconnected, a position signal is sent to the quick switching device, and the position signal can indicate that the circuit breaker of the upper-level power supply connected to the main power supply is disconnected and that power is lost from the main power supply. After receiving the position signal, the quick switching device can also determine that a trigger condition is identified. There are other specific methods for determining that a trigger condition is identified, which will not be detailed here.

It should be noted that, if a trigger condition is identified, other power data that needs to be collected may also be sampled, for example, the power data of the backup power supply, to determine the subsequent closing conditions.

Step 202, if a time period for sampling of power data reaches a preset threshold, determining whether a condition for switching on the backup power supply is satisfied according to each sampled value of the power data.

The amount of power data required for switching is determined in advance according to the sampling frequency, and then the time threshold for sampling is determined. When the time for sampling the power data reaches the time threshold, it can be decided whether the condition for switching on the backup power supply is satisfied based on the collected power data. The specific method for determining whether the switching-on condition is met is in the prior art and will not be detailed here.

In the method for power supply switching in an electric power system according to the embodiment, when a trigger condition is identified which indicates that a fault of the electric power system is eliminated and power is lost from the main power supply, the power data on the bus is immediately sampled, so that there is no need to wait for the circuit breaker of the main power to completely open before starting sampling, thereby saving time to obtain a sufficient amount of power data as soon as possible for determining whether the closing condition is met and then triggering the switching operation of the power supply as soon as possible.

### Embodiment 2

This embodiment will further explain the method for power supply switching in an electric power system of embodiment 1. In practical applications, sometimes the circuit breaker of a power supply will trip unexpectedly. Fault tripping means that a circuit breaker trips after receiving a tripping signal, and tripping signals include manual opening commands and tripping commands sent by the relay protection device. Nuisance tripping means that a circuit breaker trips without being operated or action of the relay protection device. There is a certain time interval from the start of disconnection of the circuit breaker of the main power supply to the complete disconnection. The start of disconnection indicates that it has left the closing position, and complete disconnection indicates that the circuit breaker has reached the preset open position where no electric arc will be produced. In the prior art, when the circuit breaker of the main power supply is in the open position, the electric power system loses power supply, and the voltage on the bus will gradually drop. The quick switching device will identify whether the circuit breaker of the main power supply has tripped unexpectedly according to the existing nuisance tripping determination logic, i.e., identify whether the circuit breaker of the power supply is in the open position and whether the line of the power supply is in a no-current state. After it is determined that the circuit breaker of the power supply has tripped unexpectedly, collecting power data will be started. In this way, a certain delay is produced. In view of this, this embodiment provides the method described below.

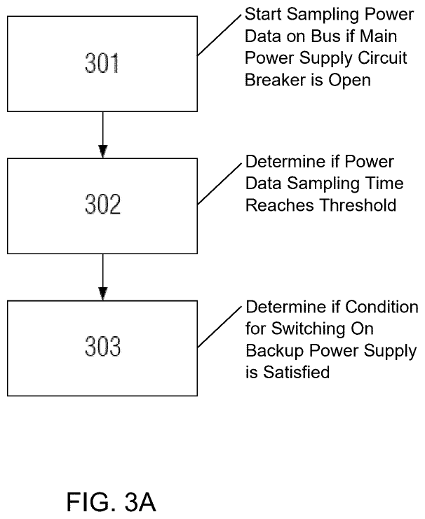

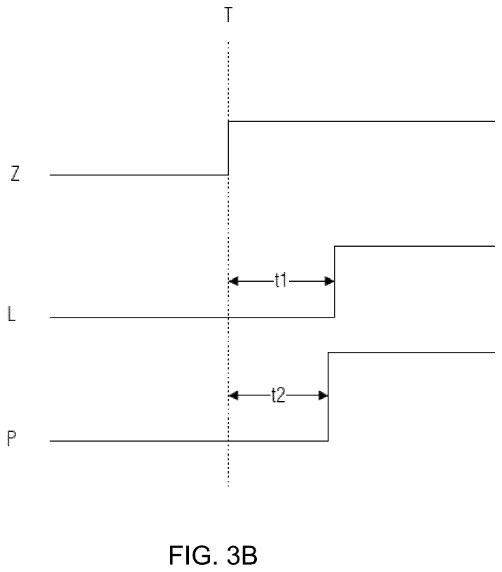

As shown in FIG. 3A, it is the method for power supply switching in an electric power system according to this embodiment. As shown in FIG. 3B, it is a schematic diagram of the time series of the events in the fast switching mode according to this embodiment.

Step 301, starting sampling of power data on the bus if position information is received indicating that the circuit breaker of the main power supply is in the open position.

The position information of the circuit breaker of the main power supply can be obtained directly by the quick switching device. For example, the circuit breaker of the main power supply and the quick switching device have a cable, through which the quick switching device can obtain the information of the position of the circuit breaker of the main power supply in real time. sampling of power data on the bus is started immediately if the quick switching device detects that the circuit breaker of the main power supply is already in the open position due to nuisance tripping.

Here, the data on the bus may be sampled specifically by sampling the voltage on the bus, to obtain a plurality of sampled voltage values.

Step 302, determining whether the time period of sampling of power data reaches a preset threshold, and performing Step 303 if the result is yes.

The total amount of power data is determined according to the corresponding determination logic. Since the total amount of power data=sampling time/sampling cycle, the preset threshold can be set in advance according to actual needs. After sufficient power data is obtained, it can be determined whether the condition for switching on the backup power supply is satisfied according to each sampled value of the power data.

Step 303, determining whether the condition for switching on the backup power supply is satisfied according to each sampled value of the power data.

Specifically, it may be determined whether the condition for switching on the backup power supply is satisfied according to each sampled value of the power data: fast switching, synchronization capture switching, and remnant voltage switching. If it is determined that the corresponding closing condition is met, the closing operation of the circuit breaker of the backup power supply is performed to complete the switch between the main power supply and the backup power supply.

As shown in FIG. 3B, it is a schematic diagram of the time series of the actions in the fast switching mode. Z represents the time series of the action of the circuit breaker of the main power supply, L represents the time series of the nuisance tripping determination logic, and P represents the time series of power data collection. Specifically, the circuit breaker of the main power supply leaves the closed position at time T, the nuisance tripping determination logic starts almost at time T and takes a period t1 to complete, acquisition of circuit data also starts almost at time T and takes a period t2 to complete the collecting of power data, and in this way the power data collection operation starts without the need of waiting for the execution of the nuisance tripping determination logic to complete.

Optionally, in this embodiment, after Step 301 and before Step 303, it further comprises: verifying whether the main power supply has no current, and performing Step 303 is the verification result is yes. The purpose of this step is to detect whether the main power supply of the electric power system has really lost power. Generally, when the circuit breaker of the main power supply is in the open position, the power supply will really be lost, and then the line of the main power supply will be in a state of no current, as shown in FIG. 1. Specifically, the current in the line on either side of the circuit breaker CB1 can be detected to determine whether the main power supply is in a no-current state. However, since the quick switching device generally obtains the position of the circuit breaker of the main power supply through signals by cable transmission, sometimes the cable may have poor contact or interference, which may cause signal mistransmission. That is, the information that the circuit breaker of the main power supply is in the opening position received by the quick switching device may be wrong, and the power data collected at this time cannot be used to determine the closing condition. That is, only when the circuit breaker of the main power supply is in the open position and it is confirmed that the main power supply has no current, will it be confirmed that the main power supply has lost power. If the line of the main power supply is not in a no-current state within the preset time period, sampling of power data will be stopped, and Step 303 is no longer performed.

According to this embodiment, when the position information indicating that the circuit breaker of the main power supply is not in the closed position is received, the operation of obtaining power data of the bus immediately starts without waiting for the operation of the quick switching device to determine whether nuisance tripping occurs, which can obtain a sufficient amount of power data as soon as possible, so that the backup power supply can be switched on as soon as possible in the event of nuisance tripping.

### Embodiment 3

This embodiment will further explain the method for power supply switching in an electric power system of the embodiment described above.

In the previous embodiment, after identifying a trigger condition, the quick switching device still needs to determine whether the circuit breaker of the main power supply is completely disconnected, and only when it is determined that the circuit breaker of the main power supply is completely disconnected, will the operation of switching to the backup power supply be performed. The line current of the main power supply should be 0 when the circuit breaker of the main power supply is completely disconnected. However, for some current transformers, the calculation methods, for example, Fourier transform, will cause a delay in the calculation, that is, the line current of the main power supply, even if already being 0, is still detected to be not 0 due to the calculation method of the current transformer, and thus the operation of switching on the backup power supply cannot be performed in time. This embodiment proposes a method that can identify in time whether the circuit breaker of the main power supply is completely disconnected, i.e., whether it is already in the open position.

Step 401, if a trigger condition is identified, starting sampling of power data on the bus, the trigger condition being used to decide that a fault of the electric power system is eliminated and power is lost from the main power supply.

This step is consistent with embodiment 1 above, for example, the trigger condition being receiving position information indicating disconnection of the circuit breaker of the main power supply, and will not be repeated here.

Step 402, monitoring the current of the main power supply, determining whether the circuit breaker is completely disconnected according to the value of the current of the main power supply, and performing Step 403 if the result is yes.

Specifically, determining whether the circuit breaker of the main power supply is completely disconnected according to the value of the current of the main power supply comprises:
obtaining a target value according to a sampled value of the current, the target value=an Nth sampled current value−an (N−1)th sampled current value, wherein N is a positive integer; and
if an absolute value of consecutive M target values is less than or equal to a preset threshold, determining that the circuit breaker of the main power supply is completely disconnected, wherein M is a positive integer.

For example, |filter(N)|=|i(N)−i(N−1)|, wherein filter (N) represents the Nth target value, i(N) represents the Nth sampled current value, and i(N−1) represents the (N−1)th sampled current value. Assuming that M is 10, if the absolute value of 10 consecutive target values is less than a preset threshold value, it means that the current of the main power supply currently supplying power is already 0, and the subsequent operation of switching on the backup power supply can be performed. The preset threshold value here may be understood as the no-current threshold, which can be set according to actual needs.

Here, M≥the number of sampled values of a half cycle of the current. The sampled current values will have a peak value within half a cycle. If the absolute value of the target value corresponding to the peak value is also less than the preset threshold, it means that the circuit breaker of the main power supply is completely disconnected.

Step 403, if the time period for sampling of power data reaches the preset threshold, determining whether the condition for switching on the backup power supply is satisfied according to each sampled value of the power data, and performing Step 404 if the result is yes.

This step is consistent with embodiment 1 described above and will not be repeated here.

Step 404, triggering the operation of switching on the backup power supply according to the collected power data.

In this way, the operation of switching on the backup power supply is performed when it is determined that the condition for switching on the backup power supply is satisfied according to the collected power data.

According to this embodiment, not only can the collection of power data be triggered as soon as possible to prepare for the switching on of the backup power supply, but also by changing the calculation method, it can be determined as soon as possible whether the circuit breaker of the main power supply is disconnected, and then the switching on of the backup power supply can be performed as soon as possible, so that the quick switching device can perform the fast switching operation earlier to ensure the continuity of power supply.

### Embodiment 4

This embodiment provides a quick switching device used for implementing the method for power supply switching in an electric power system of embodiment 1 described above. The quick switching device is located in an electric power system, the electric power system comprises two power supplies, each of the power supplies is connected to a bus through an incoming line, one power supply currently supplying power is used as the main power supply, the other power supply is used as a backup power supply, and the two power supplies are respectively connected to a power supply station of the higher level. The quick switching device can trigger the switching between the two power supplied.

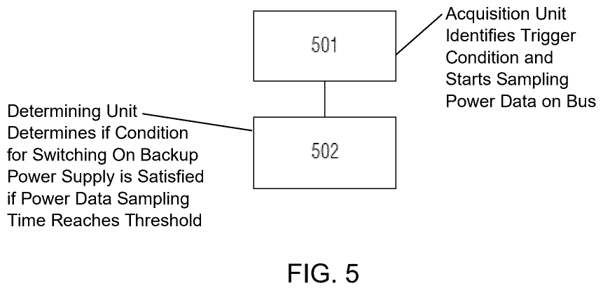

FIG. 5 is a schematic structural diagram of the quick switching device according to this embodiment. The quick switching device comprises an acquisition unit 501 and a determining unit 502.

Specifically, the acquisition unit 501 is used for, if a trigger condition is identified, starting sampling of power data on the bus, the trigger condition being used to decide that a fault of the electric power system is eliminated and power is lost from the main power supply. The determining unit 502 is used for, if the time period for sampling of power data reaches a preset threshold, determining whether a condition for switching on the backup power supply is satisfied according to each sampled value of the power data.

Optionally, the acquisition unit 501 is specifically used for: determining that a trigger condition is identified if a return signal sent by a fault detection element is received.

The methods of operation of each of the units in this embodiment are the same as in the embodiments described above, so are not described again here.

According to the embodiment, when a trigger condition is identified which indicates that a fault of the electric power system is eliminated and power is lost from the main power supply, the power data on the bus is immediately sampled, so that there is no need to wait for the circuit breaker of the main power to completely open before starting sampling, thereby saving time to obtain a sufficient amount of power data as soon as possible for determining whether the closing condition is met and then triggering the switching operation of the power supply as soon as possible.

### Embodiment 5

This embodiment will further explain the quick switching device of embodiment 4.

The acquisition unit 501 of the quick switching device of this embodiment is used for: determining that a trigger condition is identified if position information is received indicating that the circuit breaker of the main power supply is in the open position.

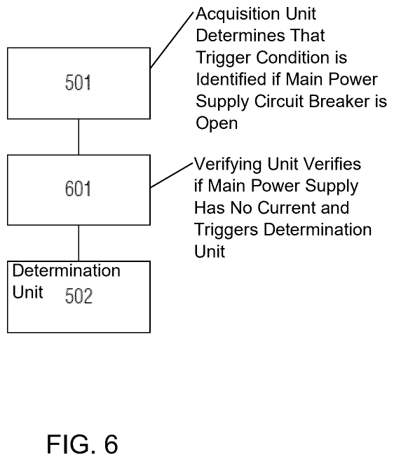

As shown in FIG. 6, the quick switching device of this embodiment further comprises a verifying unit 601, and the verifying unit 601 is used for verifying whether the main power supply has no current, and triggering the determining unit 502 if the verification result is yes.

The methods of operation of each of the units in this embodiment are the same as in the embodiments described above, so are not described again here.

According to this embodiment, when the position information indicating that the circuit breaker of the main power supply is not in the closed position is received, the operation of obtaining power data of the bus immediately starts without waiting for the operation of the quick switching device to determine whether nuisance tripping occurs, which can obtain a sufficient amount of power data as soon as possible, so that the backup power supply can be switched on as soon as possible in the event of nuisance tripping.

### Embodiment 6

This embodiment will further explain the quick switching device of embodiment 4.

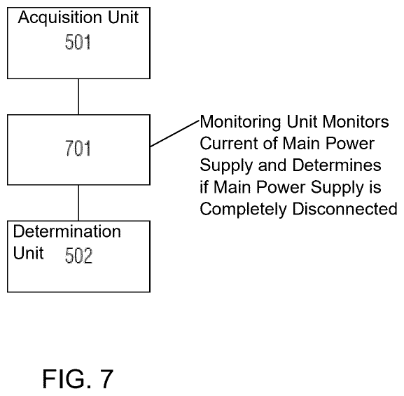

As shown in FIG. 7, the quick switching device of this embodiment further comprises a monitoring unit 701. The monitoring unit 701 is used for monitoring the current of the main power supply, and determining whether the circuit breaker of the main power supply is completely disconnected according to the value of the current of the main power supply.

The monitoring unit 701 of this embodiment is specifically used for:
obtaining a target value according to a sampled value of the current, the target value=an Nth sampled current value−an (N−1)th sampled current value, wherein N is a positive integer; and
if an absolute value of consecutive M target values is less than or equal to a preset threshold, determining that the circuit breaker of the main power supply is completely disconnected, wherein M is a positive integer and M≥a number of sampled values of a half cycle of the current.

The methods of operation of each of the units in this embodiment are the same as in the embodiments described above, so are not described again here.

According to this embodiment, not only can the collection of power data be triggered as soon as possible to prepare for the switching on of the backup power supply, but also by changing the calculation method, it can be determined as soon as possible whether the circuit breaker of the main power supply is disconnected, and then the switching on of the backup power supply can be performed as soon as possible, so that the quick switching device can perform the fast switching operation earlier to ensure the continuity of power supply.

The present invention further provides a quick switching device, comprising at least one memory and at least one processor. The memory is used to store instructions. The processor is used for executing the method for power supply switching in an electric power system described in any of the embodiments above according to the instruction stored in the memory.

An embodiment of the present invention further provides a readable storage medium. A machine-readable instruction stored is the readable storage medium, and the machine-readable instruction, when executed by a machine, causes the machine to execute the method for power supply switching in an electric power system described in any of the embodiments above.

The readable medium stores a machine-readable instruction that, when executed by a processor, causes the processor to execute any one of the above-described methods. Specifically, a system or device equipped with a readable storage medium may be provided; software program code realizing a function of any one of the embodiments above is stored on the readable storage medium, and a computer or processor of the system or device is caused to read and execute a machine-readable instruction stored in the readable storage medium.

In this case, the functions of any one of the above embodiments may be performed by a program code read from the readable medium, so a machine-readable code and a readable storage medium for storing machine-readable code constitute a part of the present invention.

Examples of readable storage media include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, the program code may be downloaded from a server computer or a cloud via a communication network.

Those skilled in the art should understand that various changes in form and amendments may be made to the embodiments disclosed above without departing from the substance of the invention. Thus, the scope of protection of the present invention shall be defined by the attached claims.

It should be noted that not all steps and units in the above-described process flows and system structure diagrams are necessary, and some steps or units may be omitted according to actual needs. The sequence in which the steps are executed is not fixed, but may be adjusted as needed. The device structure described in the above embodiments may be either a physical structure or a logical structure, which means that some units may be implemented by the same physical entity, or some units may be implemented by a plurality of physical entities separately or by some parts of a plurality of independent devices jointly.

In the embodiments above, a hardware unit may be realized in a mechanical or an electrical manner. For example, a hardware unit or processor may comprise a permanently dedicated circuit or logic (for example, a specialized processor, FPGA, or ASIC) to complete corresponding operations. A hardware unit or processor may further comprise programmable logic or circuits (such as general-purpose processors or other programmable processors), which may be temporarily set by software to complete corresponding operations. Particular embodiments (mechanical, or dedicated permanent circuitry, or temporarily set circuitry) may be determined based on considerations of cost and time.

The above are merely preferred embodiments of the present invention, which are not intended to limit it. Any amendments, equivalent substitutions or improvements etc. made within the spirit and principles of the present invention shall be included in the scope of protection thereof.

1-15. (canceled)

16. A method for power supply switching in an electric power system, the method comprising:
providing an electric power system including two power supplies, each of the power supplies being connected to a bus through an incoming line, one of the power supplies currently supplying power being used as a main power supply, another of the power supplies being used as a backup power supply, and the two power supplies being respectively connected to a power supply station of a higher level;
upon identifying a trigger condition, starting sampling of power data on the bus, and using the trigger condition to decide that a fault of the electric power system is eliminated and power is lost from the main power supply; and
upon a time period for sampling of power data reaching a preset threshold, determining whether a condition for circuit-closing of the backup power supply is satisfied according to each sampled value of the power data.

17. The method according to claim 16, which further comprises, before starting sampling of power data on the bus, determining that the trigger condition is identified when a return signal sent by a fault detection element is received.

18. The method according to claim 16, which further comprises, before starting sampling of power data on the bus, determining that the trigger condition is identified when position information is received indicating that a circuit breaker of the main power supply is in an open position.

19. The method according to claim 18, which further comprises:
after starting sampling of power data on the bus and before determining whether a condition for circuit-closing of the backup power supply is satisfied according to each sampled value of the power data:
verifying whether the circuit breaker of the main power supply has no current, and, when a verification result is positive, determining whether the condition for circuit-closing of the backup power supply is satisfied according to each sampled value of the power data.

20. The method according to claim 16, which further comprises, after a trigger condition is identified, monitoring a current of the main power supply, and determining whether a circuit breaker of the main power supply is completely disconnected according to a value of the current of the main power supply.

21. The method according to claim 20, which further comprises:
determining whether the circuit breaker of the main power supply is completely disconnected according to a value of the current of the main power supply by:
obtaining a target value according to a sampled value of the current, the target value=an N^{th} sampled current value−an (N−1)^{th} sampled current value, wherein N is a positive integer; and
when an absolute value of consecutive M target values is less than or equal to a preset threshold, determining that the circuit breaker of the main power supply is completely disconnected, wherein M is a positive integer.

22. The method according to claim 21, which further comprises selecting M≥a number of sampled values of a half cycle of the current.

23. A quick switching device located in an electric power system, the electric power system including two power supplies, each of the power supplies being connected to a bus through an incoming line, one of the power supplies currently supplying power being used as a main power supply, another of the power supplies being used as a backup power supply, and the two power supplies being respectively connected to a power supply station of a higher level,
the quick switching device comprising:
an acquisition unit configured to start sampling of power data on the bus upon a trigger condition being identified, the trigger condition being used to decide that a fault of the electric power system is eliminated and power is lost from the main power supply; and
a determining unit configured to determine, upon a time period for sampling of power data reaching a preset threshold, whether a condition for circuit-closing of the backup power supply is satisfied according to each sampled value of the power data.

24. The quick switching device according to claim 23, wherein said acquisition unit is specifically used for determining that the trigger condition is identified when a return signal sent by a fault detection element is received.

25. The quick switching device according to claim 23, wherein the acquisition unit is specifically used for determining that the trigger condition is identified when position information is received indicating that a circuit breaker of the main power supply is in an open position.

26. The quick switching device according to claim 25, which further comprises a verifying unit configured for verifying whether the circuit breaker of the main power supply has no current, and triggering the determining unit when a verification result is positive.

27. The quick switching device according to claim 23, which further comprises a monitoring unit configured for monitoring a current of the main power supply, and determining whether a circuit breaker of the main power supply is completely disconnected according to a value of the current of the main power supply.

28. The quick switching device according to claim 27, wherein said monitoring unit is specifically configured for:
obtaining a target value according to a sampled value of the current, the target value=an N^{th} sampled current value−an (N−1)^{th} sampled current value, wherein N is a positive integer; and
upon an absolute value of consecutive M target values being less than or equal to a preset threshold, determining that the circuit breaker of the main power supply is completely disconnected, wherein M is a positive integer and M≥a number of sampled values of a half cycle of the current.

29. A quick switching device, comprising:
at least one memory configured for storing an instruction;
at least one processor configured for executing the method for power supply switching in the electric power system of claim 16 according to the instruction stored in the memory.

30. A non-transitory readable storage medium, comprising a machine-readable instruction stored in the readable storage medium, which, when executed by a machine, causes the machine to execute the method for power supply switching in an electric power system according to claim 16.
